(19) United States
(12) Patent Application Publication
(10) Pub. No.: US 2026/0155465 A1
(43) Pub. Date: Jun. 4, 2026

(54) TRACTION BATTERY PACK CARTRIDGE ASSEMBLY

(71) Applicant: Ford Global Technologies, LLC, Dearborn, MI (US)

(72) Inventors: John Peter Bilezikjian, Canton, MI (US); Derek Timothy Taylor, Waterford, MI (US); Shane Greenwood, Walled Lake, MI (US)

(21) Appl. No.: 18/966,481

(22) Filed: Dec. 3, 2024

(51) Int. Cl. H01M 10/42; H01M 50/262; H01M 50/271

(52) U.S. Cl. CPC H01M 10/4257; H01M 50/262; H01M 50/271; H01M 2220/20

(57) ABSTRACT

A battery pack assembly includes a cartridge assembly having a cover and at least one electronic module. The cartridge assembly is configured to transition from an uninstalled position relative to a battery pack enclosure to an installed position relative to the battery pack enclosure. The cartridge assembly in the installed position is disposed over an opening in the battery pack enclosure with the at least one electronic module within an interior of the battery pack enclosure.

### TECHNICAL FIELD

This disclosure relates generally to a cartridge assembly that can be serviced from outside a traction battery pack enclosure and, more particularly, to a cartridge assembly that includes an electronic module.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A battery pack can power the electric machines. The battery pack of an electrified vehicle can include groups of battery cells. The battery pack can additionally include various electronic modules.

In some aspects, the techniques described herein relate to a battery pack assembly, including: a cartridge assembly having a cover and at least one electronic module, the cartridge assembly configured to transition from an uninstalled position relative to a battery pack enclosure to an installed position relative to the battery pack enclosure, the cartridge assembly in the installed position disposed over an opening in the battery pack enclosure with the at least one electronic module within an interior of the battery pack enclosure.

In some aspects, the techniques described herein relate to a battery pack assembly, further including at least one connection interface within the cover, the at least one connection interface accessible from a position outside the interior of the battery pack enclosure when the cartridge assembly is in the installed position.

In some aspects, the techniques described herein relate to a battery pack assembly, wherein the cartridge assembly is configured to transition from the uninstalled position to the installed position without accessing the interior.

In some aspects, the techniques described herein relate to a battery pack assembly, wherein the battery pack enclosure includes an enclosure lid secured to an enclosure tray, wherein the cartridge assembly is configured to transition from the installed position to the uninstalled position without separating the enclosure lid from the enclosure tray.

In some aspects, the techniques described herein relate to a battery pack assembly, further including at least one mechanical fastener securing the cartridge assembly to the battery pack enclosure when the cartridge assembly is in the installed position.

In some aspects, the techniques described herein relate to a battery pack assembly, wherein the cover includes an attachment flange, the at least one mechanical fastener extending through the attachment flange to secure the cartridge assembly to the battery pack enclosure .

In some aspects, the techniques described herein relate to a battery pack assembly, wherein the at least one mechanical fastener is accessible from outside the interior of the battery pack enclosure.

In some aspects, the techniques described herein relate to a battery pack assembly, further including a receptacle within the battery pack enclosure, the cartridge assembly slideably received within the receptacle when the cartridge assembly is in the installed position.

In some aspects, the techniques described herein relate to a battery pack assembly, wherein the cover includes an attachment flange, the at least one mechanical fastener extending through the attachment flange and the receptacle to secure the cartridge assembly to the battery pack enclosure.

In some aspects, the techniques described herein relate to a battery pack assembly, wherein the opening is in a wall of a tray of the battery pack enclosure .

In some aspects, the techniques described herein relate to a battery pack assembly, further including a receptacle within the battery pack enclosure, the cartridge assembly slideably received within the receptacle when the cartridge assembly is in the installed position.

In some aspects, the techniques described herein relate to a battery pack assembly, further including at least one coolant port of the cartridge assembly.

In some aspects, the techniques described herein relate to a battery pack assembly, wherein the at least one electronic module is a BECM.

In some aspects, the techniques described herein relate to a battery pack assembly, wherein the at least one electronic module includes a BECM, a BEC, and a DC/DC converter.

In some aspects, the techniques described herein relate to a battery pack connection method, including: from a position outside an interior of a battery pack enclosure, securing a cartridge assembly to the battery pack enclosure such that a cover of the cartridge assembly is disposed over an opening in the battery pack enclosure and at least one electronic module of the cartridge assembly is disposed within an interior of the battery pack enclosure.

In some aspects, the techniques described herein relate to a battery pack connection method, further including securing the cartridge assembly to the battery pack enclosure using at least one mechanical fastener.

In some aspects, the techniques described herein relate to a battery pack connection method, wherein the cartridge assembly can be detached and removed from the battery pack enclosure without accessing the interior.

In some aspects, the techniques described herein relate to a battery pack connection method, wherein the cover of the cartridge assembly includes at least one connector, the at least one electronic module configured to operatively couple to a component outside battery pack enclosure through the at least one connector.

In some aspects, the techniques described herein relate to a battery pack connection method, further including, from an area outside the interior of the battery pack enclosure, unsecuring the cartridge assembly from the battery pack enclosure and sliding the cartridge assembly relative to the battery pack enclosure to withdraw the at least one electronic module of the cartridge assembly from the interior of the battery pack enclosure.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a traction battery pack.

FIG. 2 illustrates an expanded, perspective view of the traction battery pack from the electrified vehicle of FIG. 1 showing a cartridge assembly of the traction battery pack in an uninstalled position according to an exemplary aspect of the present disclosure.

FIG. 3 illustrates the perspective view of FIG. 2 showing the cartridge assembly in an installed position.

FIG. 4 illustrates a section view taken at line 4-4 in FIG. 3.

FIG. 5 illustrates a section view at the position of FIG. 4 taken through a traction battery pack according to another exemplary aspect of the present disclosure.

### DETAILED DESCRIPTION

A cartridge assembly of a battery pack includes at least one electronic module. The cartridge assembly can be installed and uninstalled from outside a traction battery pack enclosure. This facilitates servicing the battery pack because, for example, separating an enclosure lid from an enclosure tray is not required to service the at least one electronic module.

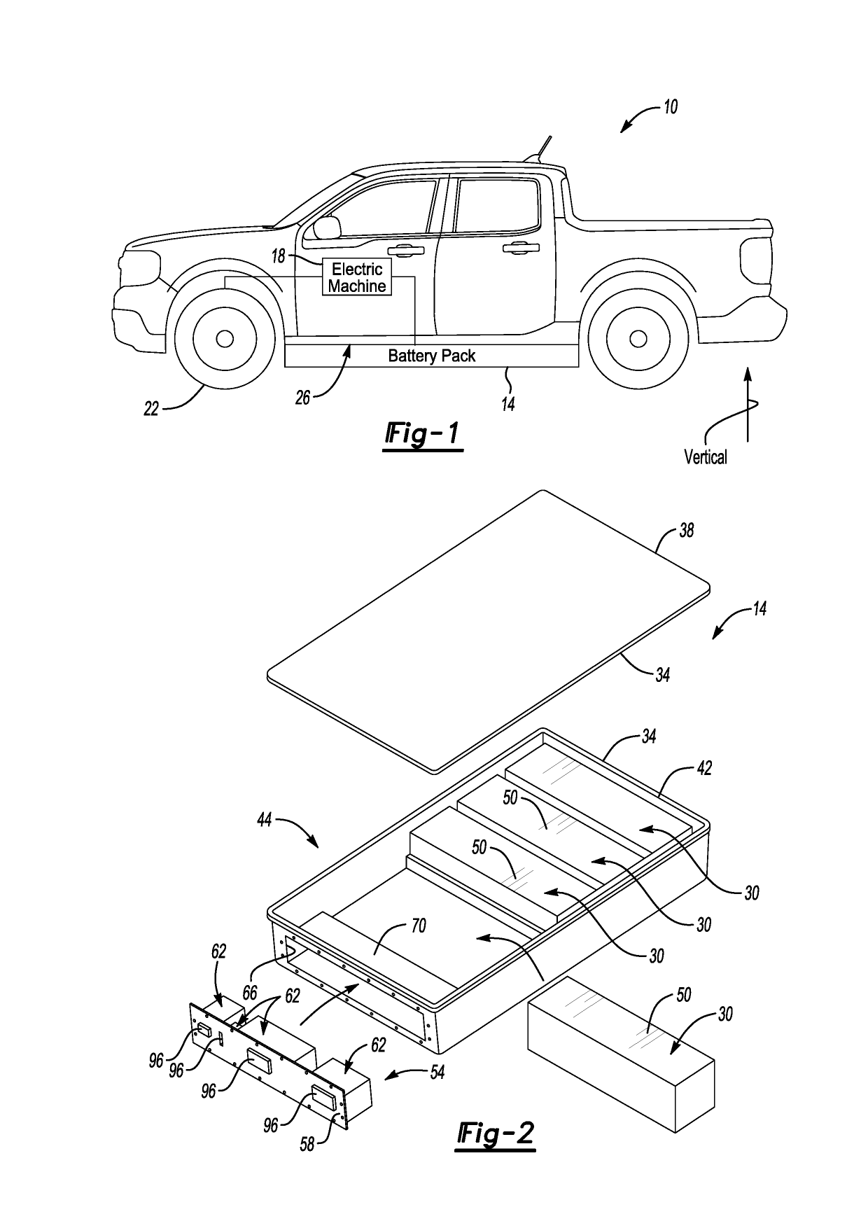

With reference to FIG. 1, an electrified vehicle 10 includes a battery pack 14, an electric machine 18, and wheels 22. The battery pack 14 powers the electric machine 18, which can convert electrical power to mechanical power to drive the wheels 22. The battery pack 14 can be a relatively high-voltage battery.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

With reference now to FIG. 2, the battery pack 14 includes a plurality of battery arrays 30 held within an enclosure assembly 34. In the exemplary embodiment, the battery pack enclosure assembly 34 includes an enclosure lid 38 and an enclosure tray 42. The battery pack enclosure lid 38 is secured to the battery pack enclosure tray 42 to provide an interior area 44 that houses the plurality of battery arrays 30.

The battery arrays 30 each includes a plurality of battery cells 50 (or simply, “cells”) stacked side-by side relative to each other. The battery cells 50 are for supplying electrical power to various components of the electrified vehicle 10.

Although a specific number of cells 50 and battery arrays 30 are illustrated in the various figures of this disclosure, the battery pack 14 could include any number of battery arrays 30 having any number of cells 50. In other words, this disclosure is not limited to the specific configuration shown in FIG. 2.

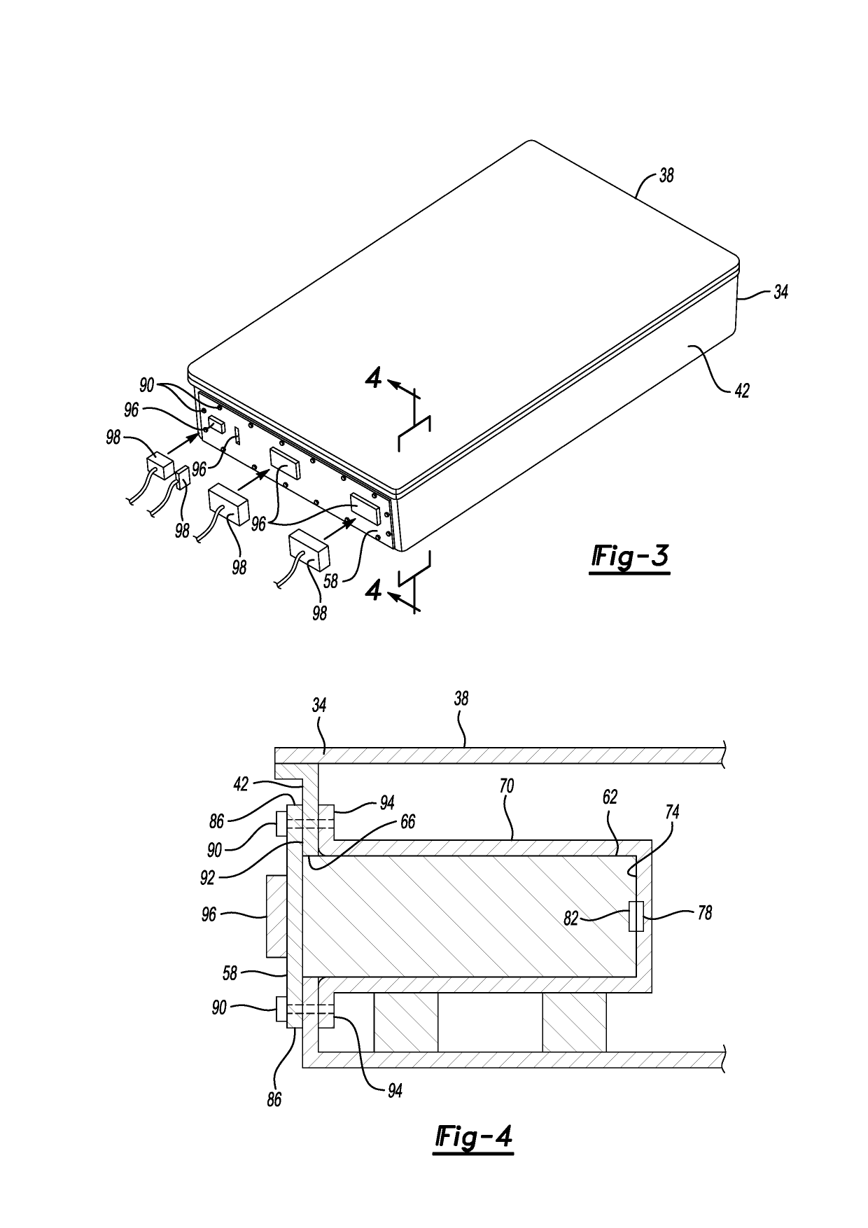

The battery pack 14 further includes a cartridge assembly 54 configured to transition from an uninstalled position as shown in FIG. 2 to an installed position as shown in FIGS. 3 and 4. The cartridge assembly 54 includes, among other things, a cover 58 and at least one electronic module 62.

The at least one electronic module 62 is secured to the cover 58 in this example. The at least one electronic module 62 can include, for example, a bussed electrical center (BEC), a battery electronic control module (BECM), a battery pack sensor module (BPSM), and a DC/DC converter.

The cartridge assembly 54 is received within an opening 66 in the battery pack enclosure assembly 34 when the cartridge assembly 54 is in the installed position. When the cartridge assembly 54 is in the installed position, the cover 58 is disposed over the opening 66, and the at least one electronic module 62 is disposed within the interior area 44 of the battery pack 14.

In this example, the opening 66 that receives the cartridge assembly 54 is in the enclosure tray 42 of the enclosure assembly 34. The cartridge assembly 54 could be received within openings within other areas of the enclosure assembly 34 in other examples.

In this example, the cartridge assembly 54 is received within a receptacle 70 established within the interior area 44 of the enclosure assembly 34. The cartridge assembly 54 is slideably received within the receptacle 70 in this example. The receptacle 70 aligns and supports the cartridge assembly 54 as the cartridge assembly 54 is moved to the installed position.

A back wall 74 of the receptacle 70 includes electrical connectors 78. When the cartridge assembly 54 is in the installed position, electrical connectors 82 of the at least one electronic module 62 can operatively couple to the electrical connectors 78. The electrical connectors 78 and the electrical connectors 82 are electrically coupled together as the cartridge assembly 54 slides into the installed position similar to a pullout vehicle radio.

In some examples, the cartridge assembly 54 additionally includes at least one coolant port. The at least one coolant port can fluidly couple to a respective coolant conduit within the interior area 44 when the cartridge assembly 54 is transitioned from the uninstalled position to the installed position.

The cover 58 of the cartridge assembly 54 includes an attachment flange 86. When the cartridge assembly 54 is in the installed position of FIGS. 3 and 4, a plurality of mechanical fasteners 90 extend through apertures in the attachment flange 86 to threadably engage the enclosure assembly 34, a flange 94 of the receptacle 70, or both. In this example, the mechanical fasteners 90 are bolts. A seal 92 can extend about the opening 66 and can be compressed between the attachment flange 86 and the enclosure tray 42 as the mechanical fasteners 90 secure the cartridge assembly 54.

To transition the cartridge assembly 54 from the installed position of FIGS. 3 and 4 back to the uninstalled position of FIG. 2, the mechanical fasteners 90 can be removed. The cartridge assembly 54 can then slide out of the receptacle 70 to the uninstalled position so that the at least one electronic module 62 can be serviced. Servicing can include repairing or replacing the at least one electronic module 62 of the cartridge assembly 54, fuses, contactors, circuit boards, sensors, etc.

Notably, the cartridge assembly 54 can be transitioned from the uninstalled position to the installed position, and then from the installed position back to the uninstalled position from an area outside the enclosure assembly 34 and without requiring access to the interior area 44 of the enclosure assembly 34. The enclosure lid 38 can thus remain secured to the enclosure tray 42 via mechanical fasteners, such as screws or rivets, or welds or by some other securing technique, when the cartridge assembly 54 is transitioned back-and-forth between the uninstalled position and the installed position. Disrupting the welds or mechanical fasteners is not necessary to service the at least one electronic module 62 of the cartridge assembly 54.

Each electronic module 62 can include an associated connection interface 96 that extends through the cover 58. The connection interfaces 96 can be engaged and disengaged by connectors 98 when the at least one electronic module 62 is in the installed position. The connectors 98 can engage to the connection interface 96 to operatively couple the at least one electronic module 62 to a component that is outside the enclosure assembly 34. The connectors 98 can be detached from the associated connection interface 96 when the cartridge assembly 54 is withdrawn from the installed position.

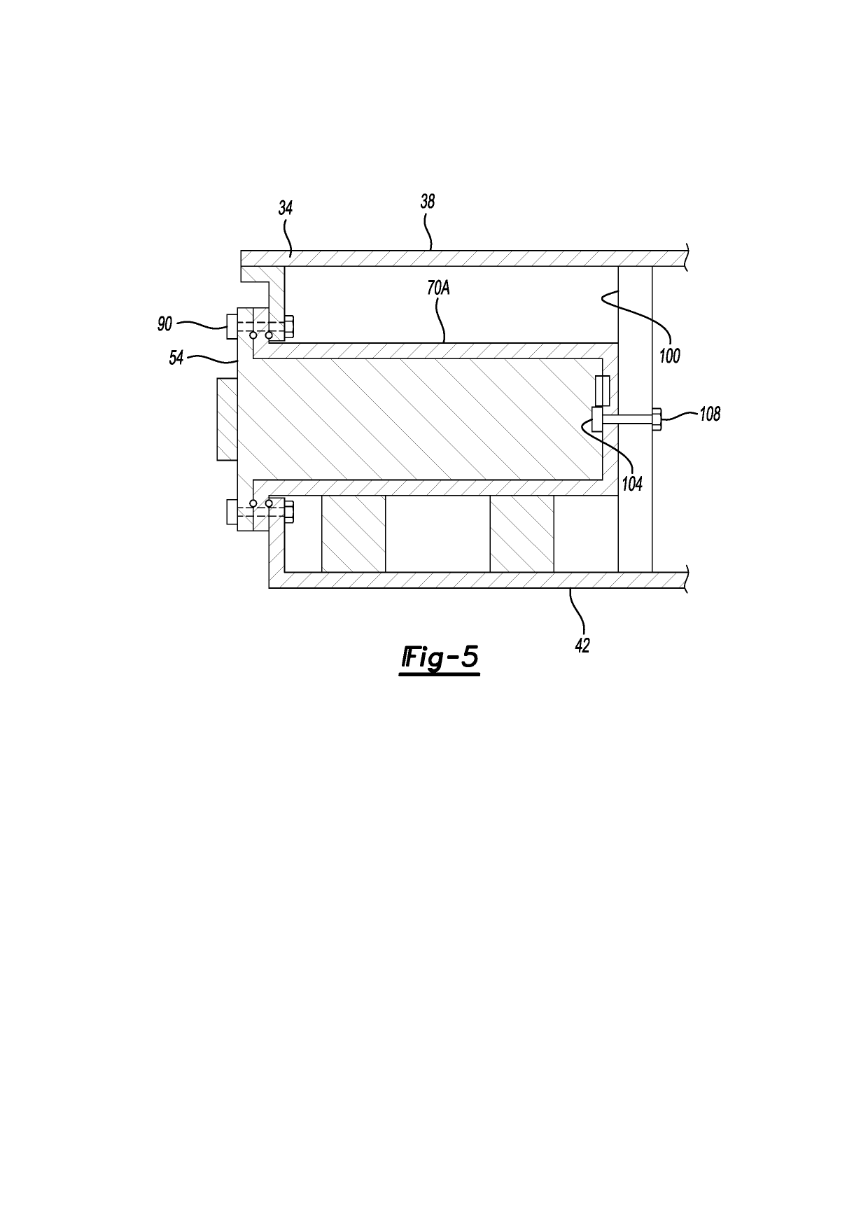

With reference to FIG. 5, another example embodiment includes a receptacle 70A that can be installed and removed from outside the enclosure assembly 34. The receptacle 70A can be secured to a structure 100 inside the enclosure assembly 34 with a mechanical fastener 104, for example. The structure 100 can be a busbar with a captive nut 108 that is engaged by the fastener 104. The mechanical fastener 104 can be accessed by withdrawing the cartridge assembly 54 from the receptacle 70A.

The receptacle 70A can be secured to the enclosure assembly 34 with the mechanical fasteners 90 that also secure the cartridge assembly 54.

Features of the disclosed examples include incorporating at least one electronic module into a cartridge assembly that can be installed and uninstalled without requiring access to an interior area of an enclosure assembly, or any extra service access cover. This can simplify servicing of the at least one electronic module.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack assembly, comprising:
a cartridge assembly having a cover and at least one electronic module, the cartridge assembly configured to transition from an uninstalled position relative to a battery pack enclosure to an installed position relative to the battery pack enclosure, the cartridge assembly in the installed position disposed over an opening in the battery pack enclosure with the at least one electronic module within an interior of the battery pack enclosure.

2. The battery pack assembly of claim 1, further comprising at least one connection interface within the cover, the at least one connection interface accessible from a position outside the interior of the battery pack enclosure when the cartridge assembly is in the installed position.

3. The battery pack assembly of claim 1, wherein the cartridge assembly is configured to transition from the uninstalled position to the installed position without accessing the interior.

4. The battery pack assembly of claim 1, wherein the battery pack enclosure includes an enclosure lid secured to an enclosure tray, wherein the cartridge assembly is configured to transition from the installed position to the uninstalled position without separating the enclosure lid from the enclosure tray.

5. The battery pack assembly of claim 1, further comprising at least one mechanical fastener securing the cartridge assembly to the battery pack enclosure when the cartridge assembly is in the installed position.

6. The battery pack assembly of claim 5, wherein the cover includes an attachment flange, the at least one mechanical fastener extending through the attachment flange to secure the cartridge assembly to the battery pack enclosure .

7. The battery pack assembly of claim 5, wherein the at least one mechanical fastener is accessible from outside the interior of the battery pack enclosure.

8. The battery pack assembly of claim 5, further comprising a receptacle within the battery pack enclosure, the cartridge assembly slideably received within the receptacle when the cartridge assembly is in the installed position.

9. The battery pack assembly of claim 8, wherein the cover includes an attachment flange, the at least one mechanical fastener extending through the attachment flange and the receptacle to secure the cartridge assembly to the battery pack enclosure.

10. The battery pack assembly of claim 1, wherein the opening is in a wall of a tray of the battery pack enclosure .

11. The battery pack assembly of claim 1, further comprising a receptacle within the battery pack enclosure, the cartridge assembly slideably received within the receptacle when the cartridge assembly is in the installed position.

12. The battery pack assembly of claim 1, further comprising at least one coolant port of the cartridge assembly.

13. The battery pack assembly of claim 1, wherein the at least one electronic module is a BECM.

14. The battery pack assembly of claim 1, wherein the at least one electronic module comprises a BECM, a BEC, and a DC/DC converter.

15. A battery pack connection method, comprising:
from a position outside an interior of a battery pack enclosure, securing a cartridge assembly to the battery pack enclosure such that a cover of the cartridge assembly is disposed over an opening in the battery pack enclosure and at least one electronic module of the cartridge assembly is disposed within an interior of the battery pack enclosure.

16. The battery pack connection method of claim 15, further comprising securing the cartridge assembly to the battery pack enclosure using at least one mechanical fastener.

17. The battery pack connection method of claim 15, wherein the cartridge assembly can be detached and removed from the battery pack enclosure without accessing the interior.

18. The battery pack connection method of claim 15, wherein the cover of the cartridge assembly includes at least one connector, the at least one electronic module configured to operatively couple to a component outside battery pack enclosure through the at least one connector.

19. The battery pack connection method of claim 15, further comprising, from an area outside the interior of the battery pack enclosure, unsecuring the cartridge assembly from the battery pack enclosure and sliding the cartridge assembly relative to the battery pack enclosure to withdraw the at least one electronic module of the cartridge assembly from the interior of the battery pack enclosure.
